(19) United States
(12) Patent Application Publication
(10) Pub. No.: US 2013/0183632 A1
(43) Pub. Date: Jul. 18, 2013

(54) UNIVERSAL LINGUAL BRACKET SYSTEM

(71) Applicants: Weihong Huang, Guangzhou City (CN); Jiuxiang Lin, Guangzhou City (CN); Hongwei Wang, Guangzhou City (CN); Zuan Li, Guangzhou City (CN); Weidong Kong, Guangzhou City (CN)

(72) Inventors: Weihong Huang, Guangzhou City (CN); Jiuxiang Lin, Guangzhou City (CN); Hongwei Wang, Guangzhou City (CN); Zuan Li, Guangzhou City (CN); Weidong Kong, Guangzhou City (CN)

(73) Assignee: GUANGZHOU RITON BIOMATERIAL CO.,LTD., Guangzhou City (CN)

(21) Appl. No.: 13/521,394

(22) PCT Filed: Dec. 10, 2010
(86) PCT No.: PCT/CN2010/079642

§ 371 Date: Jul. 10, 2012

(30) Foreign Application Priority Data
Sep. 10, 2010 (CN) 201010280649.5

(51) Int. Cl. A61C 7/28

(52) U.S. Cl. CPC A61C 7/28
USPC 433/10

(57) ABSTRACT

The present invention discloses a universal lingual bracket system, comprising No. 1-7 universal lingual brackets connected in series by an arch wire. The universal lingual bracket includes a base plate and a bracket body portion that are integrated as a whole. A mesh bottom is arranged on the base plate and the mesh bottom is integrally molded with the base plate. The mesh bottom, the base plate and the bracket body portion are integrally molded. In addition, the mesh bottom is in the structure of an interlaced woven wire mesh, so that the universal lingual brackets have strong capability to be against the teeth surfaces and they are unlikely to come off. Even if they come off, they will not damage the mesh bottom. The mesh bottom can be used again once it is treated by sandblasting. The universal lingual bracket system provided by the invention has the advantages that it can be securely and easily installed and has high durability; therefore it is applicable to various universal lingual appliances.

### FIELD OF THE INVENTION

The present invention relates to a lingual bracket system, more particularly to a universal lingual bracket system.

### BACKGROUND OF THE INVENTION

In orthodontic treatment, in order to solve the problems that labial portions do not looks nice and patients feel uncomfortable, lingual appliances are frequently used, especially universal lingual appliances with high compatibility. A universal lingual appliance is composed of a universal lingual bracket system, an archwire and an elastic pressure ring. The universal lingual bracket system comprises different types of universal lingual brackets, which are made according to different dental patterns, i.e. different universal lingual brackets for different tooth number. Teeth are classified with different numbers, for example, central incisor (i.e. incisor) is tooth No. 1, the second molar is tooth No. 7, and so forth. Accordingly, the universal lingual brackets are also numbered from 1-7. A universal lingual bracket includes a base plate and a bracket body portion as a whole. The base plate is abutted with the lingual tooth surface and the abutted surface is disposed with a mesh bottom. Generally, the bracket body portion is provided with a slot, a crimpable hook and a tie wing. The archwire is embedded into the slot of the universal lingual bracket to connect all the universal lingual brackets, and then used to tie the tie wing at the No. 7 universal lingual bracket. Since the universal lingual brackets are tightly against the lingual teeth surfaces and connected by the archwire in series, the original tooth type can be gradually corrected into the intended tooth type under the interaction force between the archwire and the slot. In order to tie the tie wing, the dentist firstly hangs the lower portion of the elastic pressure ring on the guiding groove, then places the probe on the upper end of the tie wing, and finally uses the front end of the probe to move the upper portion of the elastic pressure ring around the tie wing, allowing the elastic pressure ring to surround the middle portion between the crimpable hook and the tie wing to fasten the universal lingual bracket on the archwire. Conventionally, a rough universal lingual bracket is firstly made and then the separately produced mesh bottom is welded on the base plate. Because it is two parts that are welded together, the mesh bottom is likely to be separated from the universal lingual bracket. The separated mesh bottom is easy to be damaged to make the universal lingual bracket unable to be used normally. Therefore the durability of the universal lingual brackets is low. With respect to a conventional universal lingual bracket system, when the elastic pressure ring is used to fasten the tie wing on teeth No. 1-3, the probe does not have the support point due to the structure and position of the teeth No. 1-3. The probe is likely to slide when the elastic pressure ring is moved and the fastening process will be difficult. In addition, the conventional universal lingual bracket system is easy to be accurately fastened when it is installed on teeth No. 6 and 7. However, when it is installed on teeth No. 1-5, the positioning will become difficult and the tooth correction result will be less satisfactory under the interaction force between the archwire and the slot because of the shorter slot and the shorter contact length after the archwire is assembled to the No. 1-5 universal lingual brackets.

### SUMMARY OF THE INVENTION

In view of the above-described problems, it is one objective of the invention to provide a universal lingual bracket system, which has the advantages that the mesh bottom is unlike to come off and the installation is secure and convenient.

The technical solution of the invention is as follows:

A universal lingual bracket system, in accordance with the invention, comprises No. 1-7 universal lingual brackets connected in series by an archwire and the lingual bracket includes a base plate and a bracket body portion that are integrated as a whole. A mesh bottom is arranged on the abutted surface formed between the base plate and the lingual tooth surface, and the mesh bottom is integrally molded with the base plate.

As a further preferred embodiment, the mesh bottom is in the structure of an interlaced woven wire.

As a further preferred embodiment, the mesh bottom is integrally molded with the base plate.

As a further preferred embodiment, the base plate includes a crimpable hook, located at the teeth root where the bracket body portion is against the lateral side; at least one tie wing, disposed on the No. 1-6 universal lingual brackets and located at the crown where the bracket body portion is against the lateral side; and a slot, disposed on the bracket body portion and in the No. 1-6 universal lingual brackets, located between the crimpable hook and the tie wing as well as in the No. 7 lingual bracket, and directly passes through the bracket body portion to form a square channel.

As a further preferred embodiment, the end of the tie wing is disposed with a guiding groove.

As a further preferred embodiment, the guiding groove is an arc-shaped recess and only disposed on the tie wing of the No. 1-3 universal lingual brackets.

As a further preferred embodiment, the length of the slot on the No. 1-5 universal lingual brackets is larger than the width of the corresponding tie wing.

As a further preferred embodiment, the No. 1-5 universal lingual brackets each has one tie wing while the No. 6 universal lingual bracket has two tie wings that are parallel at the same side.

As a further preferred embodiment, an auxiliary tie wing is disposed aside the crimpable hook of the No. 6 universal lingual bracket.

Advantages of the invention are summarized below: the mesh bottom, the base plate and the bracket body portion are integrally molded and the mesh bottom is in the structure of an interlaced woven wire, so that the universal lingual brackets have strong capability to be against the teeth surfaces and they are unlikely to come off. Even if they come off, they will not damage the mesh bottom. In addition, the mesh bottom can be used again once it is treated by sandblasting. The present invention allows the universal lingual brackets to be securely and conveniently installed with high durability, therefore it is applicable to various universal lingual appliances.

Additionally, a guiding groove is disposed on the No. 1-3 universal lingual brackets, thus the probe has a support point when the elastic pressure ring is moved and it is easier to fasten the tie wing. The slot of the No. 1-5 universal lingual brackets is lengthened; therefore, after the archwire is assembled to the universal lingual brackets, their contact length is prolonged and then it is easier for positioning. Apart from that, the tooth correction result will be more satisfactory.

### BRIEF DESCRIPTION OF THE DRAWINGS

The present invention is explained in further detail below with reference to the attached drawings and embodiment.

FIG. 1 is an axonometric diagram of No. 1-3 universal lingual brackets of the invention;

FIG. 2 is an axonometric diagram of No. 4-5 universal lingual brackets of the invention;

FIG. 3 is an axonometric diagram of No. 6 universal lingual bracket of the invention;

FIG. 4 is an axonometric diagram of No. 7 universal lingual bracket of the invention; and

FIG. 5 is a structural representation of a mesh bottom of the invention.

### DETAILED DESCRIPTION OF THE EMBODIMENTS

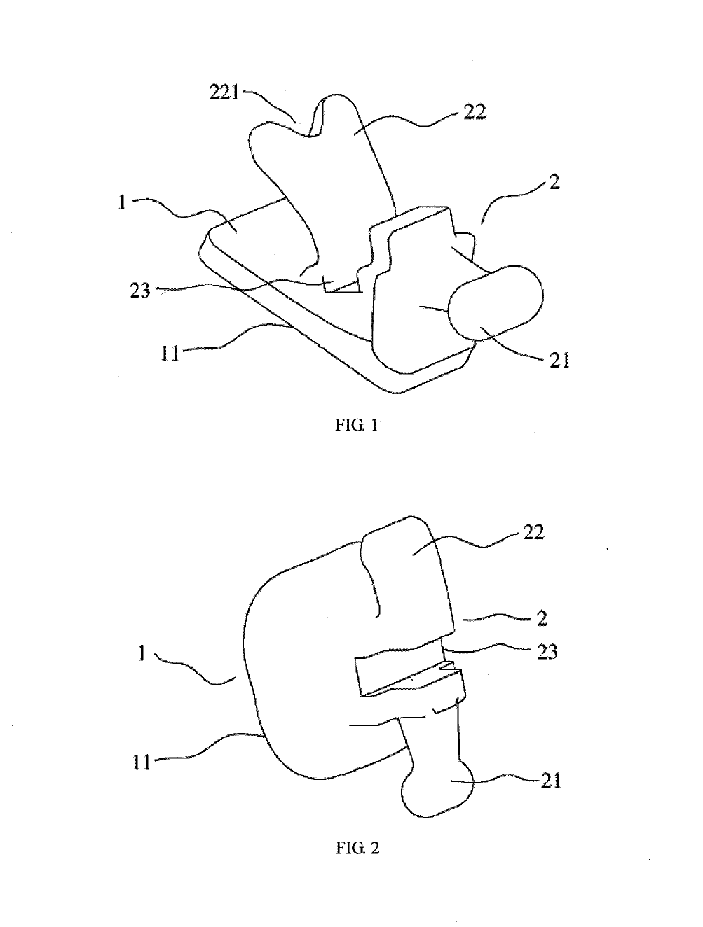

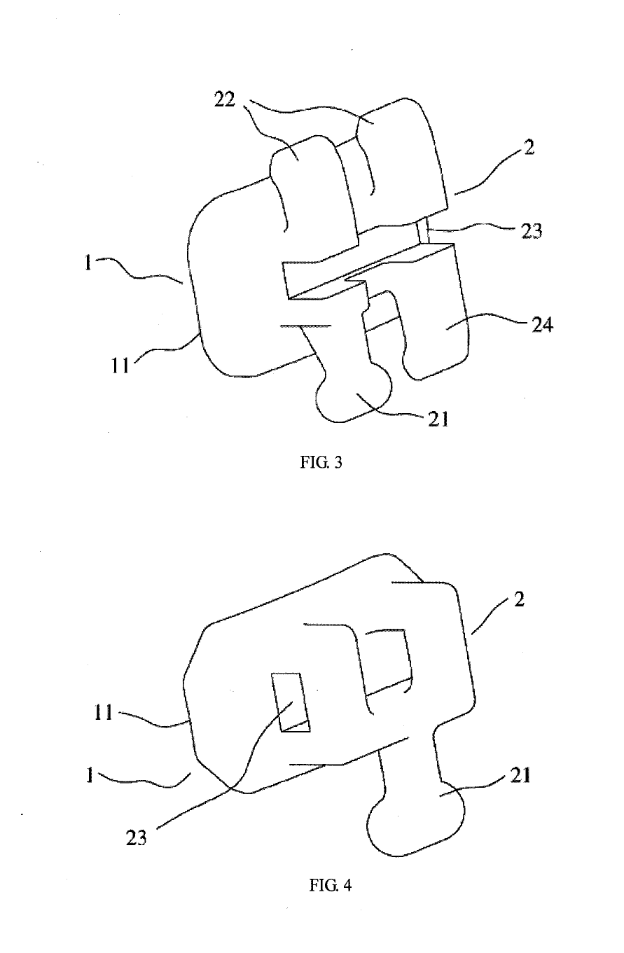

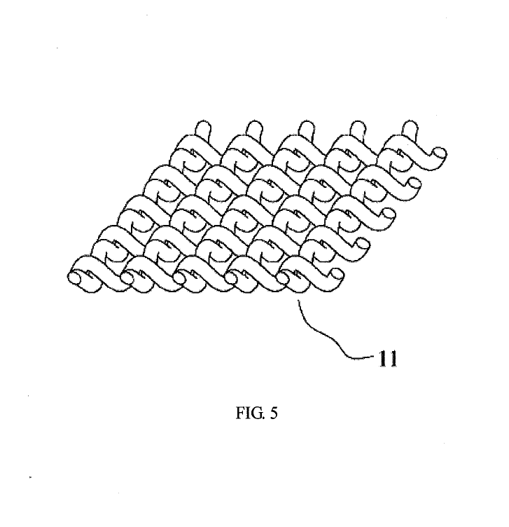

As shown in FIGS. 1-5, a universal lingual bracket system, a universal lingual bracket system, in accordance with the invention, comprises No. 1-7 universal lingual brackets connected in series by an archwire. The lingual bracket includes a base plate 1 and a bracket body portion 2 that are integrated as a whole. A mesh bottom 11 is arranged on the abutted surface formed between the base plate 1 and the lingual tooth surface, and the mesh bottom 11 is integrally molded with the base plate 1.

As a further preferred embodiment, the mesh bottom 11 is in the structure of an interlaced woven wire.

As a further preferred embodiment, the mesh bottom 11 is integrally molded with the base plate 1. Specifically, the universal lingual bracket is firstly designed in CAD software with a 3D digital model, then it is made into a resin model by means of DLP digital projection technology and finally it is made by investment casting. In fact, the mesh bottom 11 is drawn on the base plate 1 in CAD or assembled with the base plate together. The wire diameter of the mesh bottom 11 is 0.05-1 mm and the mesh number thereof is 20-200.

As a further preferred embodiment, the base plate 1 includes a crimpable hook 21, located at the teeth root where the bracket body portion is against the lateral side; at least one tie wing 22, disposed on the No. 1-6 universal lingual brackets and located at the crown where the bracket body portion is against the lateral side; and a slot 23, disposed on the bracket body portion 2 and in the No. 1-6 universal lingual brackets, located between the crimpable hook 21 and the tie wing 22 as well as in the No. 7 lingual bracket, and directly passes through the bracket body portion 2 to form a square channel.

As a further preferred embodiment, the end of the tie wing 22 is disposed with a guiding groove 221.

As a further preferred embodiment, the guiding groove 221 is an arc-shaped recess with 1-10 mm arc radius and 0.5-2 mm arc length and only disposed on the tie wing 22 of the No. 1-3 universal lingual brackets.

As a further preferred embodiment, the length of the slot 23 on the No. 1-5 universal lingual brackets is larger than the width of the corresponding tie wing 22. The length of the slot 23 on the No. 1-5 universal lingual brackets is 1.2-3.2 mm and the width of the tie wing 22 is 0.8-2.0 mm.

As a further preferred embodiment, the No. 1-5 universal lingual brackets each has one tie wing 22 while the No. 6 universal lingual bracket has two tie wings 22 that are parallel at the same side.

As a further preferred embodiment, an auxiliary tie wing 24 is disposed aside the crimpable hook 21 of the No. 6 universal lingual bracket.

When to assemble the lingual appliance, each universal lingual bracket is firstly pressed against the corresponding lingual tooth surface, then have the archwire embedded into the slot 23, allow the archwire directly pass through the slot 23 with respect to the No.7 universal lingual bracket, and finally assemble elastic pressure rings to fix the whole appliance. When to install the elastic pressure ring on No.1-3 universal lingual brackets, one end of the elastic pressure ring is firstly hanged on the crimpable hook 21, use a probe to hold the elastic pressure ring, use the guiding groove 221 as the support point to rotate the probe to make the other end of the elastic pressure ring to pass around the tie wing, and then loose the probe, the elastic pressure ring will automatically fasten the universal lingual brackets with the archwire. When to install the elastic pressure ring on the No. 6 universal lingual bracket, the auxiliary tie wing 24 has to be fastened with the tie wing 22 together.

The aforementioned embodiment is only a preferred example of the invention and shall not be used to restrict the invention. It will be obvious to those skilled in the art to make changes and modifications without departing from the invention in its broader aspects and all changes and modifications are deemed to be within the applied scope of the invention.

1. A universal lingual bracket system, comprising:
No. 1-7 universal lingual brackets connected in series by an archwire,
the lingual bracket includes a base plate and a bracket body portion that are integrated as a whole,
wherein a mesh bottom is arranged on the abutted surface formed between the base plate and the lingual tooth surface, and
the mesh bottom is integrally molded with the base plate.

2. The universal lingual bracket system of claim 1, wherein the mesh bottom is in the structure of an interlaced woven wire.

3. The universal lingual bracket system of claim 1 or 2, wherein the mesh bottom is integrally molded with the base plate.

4. The universal lingual bracket system of claim 1, wherein the base plate including:
a crimpable hook, located at the teeth root where the bracket body portion is against the lateral side;
at least one tie wing, disposed on the No. 1-6 universal lingual brackets and located at the crown where the bracket body portion is against the lateral side;
a slot, disposed on the bracket body portion and in the No. 1-6 universal lingual brackets, located between the crimpable hook and the tie wing as well as in the No. 7 lingual bracket, and directly passes through the bracket body portion to form a square channel.

5. The universal lingual bracket system of claim 4, wherein the end of the tie wing is disposed with a guiding groove.

6. The universal lingual bracket system of claim 5, wherein the guiding groove is an arc-shaped recess and only disposed on the tie wing of the No. 1-3 universal lingual brackets.

7. The universal lingual bracket system of claim 4, 5 or 6, wherein the length of the slot on the No. 1-5 universal lingual brackets is larger than the width of the corresponding tie wing.

8. The universal lingual bracket system of claim 4, 5 or 6, wherein the No. 1-5 universal lingual brackets each has one tie wing while the No. 6 universal lingual bracket has two tie wings that are parallel at the same side.

9. The universal lingual bracket system of claim 7, wherein the No. 1-5 universal lingual brackets each has one tie wing while the No. 6 universal lingual bracket has two tie wings that are parallel at the same side.

10. The universal lingual bracket system of claim 4, wherein an auxiliary tie wing is disposed aside the crimpable hook of the No. 6 universal lingual bracket.
